(19) United States
(12) Patent Application Publication
(10) Pub. No.: US 2018/0286270 A1
(43) Pub. Date: Oct. 4, 2018

(54) VIOLIN TRAINING APPARATUS AND PROCESS

(71) Applicant: BRUCE A CARTER, Miami Beach, FL (US)

(72) Inventor: BRUCE A CARTER, Miami Beach, FL (US)

(21) Appl. No.: 15/942,774

(22) Filed: Apr. 2, 2018

Related U.S. Application Data
(60) Provisional application No. 62/479,372, filed on Mar. 31, 2017.

(51) Int. Cl. G09B 15/06

(52) U.S. Cl. CPC G09B 15/06; G10D 1/02

(57) ABSTRACT

A Violin & Bow Primer having a bow guide and a guide housing that is adjustable to accurately mimic the bow stroke angle for the four strings of the violin G, D, A, and E is provided.

### RELATED APPLICATIONS

This application claims the benefit of U.S. Application Ser. No. 62/479,372 filed on Mar. 31, 2017 and which is incorporated herein by reference.

### FIELD OF THE INVENTION

This invention is directed towards a violin and bow teaching apparatus (Violin & Bow Primer) that teaches proper hand motions for string instruments. The apparatus providing a swiveling “bow guide” on the center of a training instrument and also providing a bulbous redesign of the frog the area of the bow where the player holds the bow.

The Violin & Bow Primer provides a introduction to string study in three distinct ways: 1) the instrument is virtually indestructible and can be painted and drawn on; 2) the low cost allows students to try an instrument with little economic downside; 3) solid foundational movements are encouraged in ways that make transitioning to a traditional instrument easier.

### BACKGROUND OF THE INVENTION

This invention relates generally to an apparatus and process for teaching the proper techniques for playing stringed instruments such as a violin. The violin and viola are distinctive among acoustical instruments in how they are physically held and played. The instrument is placed on the left shoulder, slightly under the chin, and fingered with the left hand, while the right hand operates the bow. This positioning can present what seem to be insurmountable challenges for a beginner string student. What makes string education unique is the focus on fine motor skills that must be mastered so that tone (right hand) and intonation (left hand) are controlled. Beginning string instrument must be kinesthetic in nature to be successful.

Accordingly, there remains room for improvement and variation within the art.

### SUMMARY OF THE INVENTION

It is one aspect of at least one of the present embodiments to provide for a Violin & Bow Primer having a bow guide and a guide housing that is adjustable to accurately mimic the bow stroke angle for the four strings of the violin G, D, A, and E.

It is a further aspect of at least one of the present embodiments to provide for a Violin & Bow Primer having an ergonomically designed shoulder rest and chin rest.

It is a further aspect of at least one of the present embodiments of the invention to provide for a Violin & Bow Primer having a fingerboard with for indentations that teach the proper placement for notes in reference to the first position.

It is a further aspect of at least one embodiment of the present invention to provide for a Violin & Bow Primer having an intermediate grip portion that provides new students with a way of learning to hold the instrument that will allow proper balance and proper left arm form.

It is a further aspect of at least one embodiment of the present invention to provide for a Violin & Bow Primer having removable shoulder and chin rest which can be replaced with different sizes in order to accommodate an individual's needs.

It is a further aspect of at least one embodiment of the present invention to provide for a Violin & Bow Primer in which there is an adjustable Bow Guide having indented notches that allows the Bridge Guide to snap the angles that mimic the G, D, A, and E string.

It is a further aspect of at least one embodiment of the present invention to provide for a Violin & Bow Primer that has a notched Bow Guide that allows for an adjustable bridge to lock into place at any one of four different angles.

It is a further aspect of at least one embodiment of the present invention to provide for a Violin & Bow Guide that allows for finger indentations for the left hand in order to form the first position on the violin, the apparatus further defining an indent to show proper thumb placement of the left hand.

### BRIEF DESCRIPTION OF THE DRAWINGS

A fully enabling disclosure of the present invention, including the best mode thereof to one of ordinary skill in the art, is set forth more particularly in the remainder of the specification, including reference to the accompanying drawings.

FIG. 1 shows the ergonomically designed shoulder rest and chin rest. Additionally, the Bow Guide, and Guide Housing adjust to accurately mimic the bow stroke angle of the four strings of the violin G, D, A, and E.

FIG. 2 the fingerboard has four indentations that lead the hand to the first notes played on the instrument called first position. The intermediate grip provides neophyte students with a way of learning to hold in the instrument in the very beginning to address issues of balance, and proper left arm form.

FIG. 3 is the design of the shoulder and chin rests can be removed. This allows for the shoulder rest and chin rest pieces to come in different sizes to meet the needs of people with various neck sizes.

FIG. 4 is a close up of the adjustable bow guide. The Bow Guide has indented notches that allow the Bridge guide to snap the angles that mimic the G, D, A, and E string.

FIG. 5 is the close up of the Bow Guide shows the notches that allow the adjustable bridge to lock into place at four different angles.

FIG. 6 is a close up of the left hand shape and indentations for fingers to form the first position on the violin. In addition to being indentations for the four fingers on the fingerboard, there is additionally an indent to show thumb placement.

FIG. 7 is a perspective view of one embodiment of the invention.

FIG. 8 is a perspective view of one embodiment of the invention illustrated next to a traditional violin.

### DESCRIPTION OF THE PREFERRED EMBODIMENT

Reference will now be made in detail to the embodiments of the invention, one or more examples of which are set forth below. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used on another embodiment to yield a still further embodiment. Thus, it is intended that the present invention cover such modifications and variations as come within the scope of the appended claims and their equivalents. Other objects, features, and aspects of the present invention are disclosed in the following detailed description. It is to be understood by one of ordinary skill in the art that the present discussion is a description of exemplary embodiments only and is not intended as limiting the broader aspects of the present invention, which broader aspects are embodied in the exemplary constructions.

In describing the various figures herein, the same reference numbers are used throughout to describe the same material, apparatus, or process pathway. To avoid redundancy, detailed descriptions of much of the apparatus once described in relation to a figure is not repeated in the descriptions of subsequent figures, although such apparatus or process is labeled with the same reference numbers.

The violin/viola requires a student to coordinate both the left and right hands, while engaged in completely different functions, each presenting their own exceptional challenges. The left hand is used to finger the notes. Unlike the guitar, the violin has no frets to guide the player in the positioning of their fingers. The intonation of the instrument, or the ability to play in tune, rests with the placement of the fingers of the left hand. It takes steady practice to develop the muscle memory to ensure correct placement of the fingers.

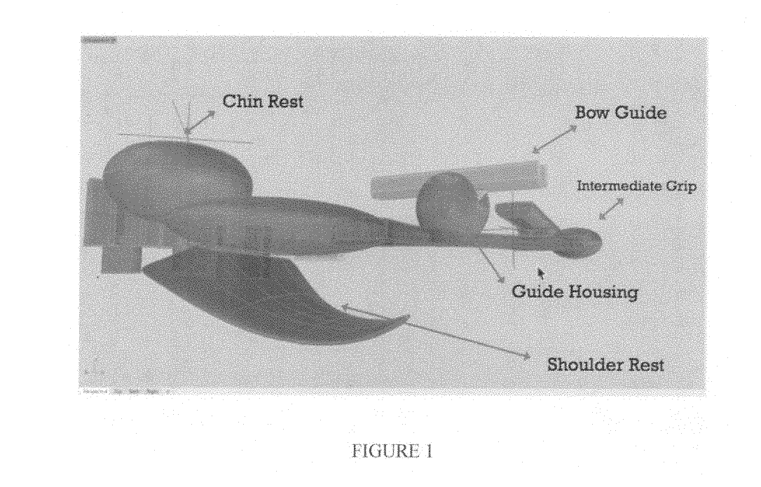

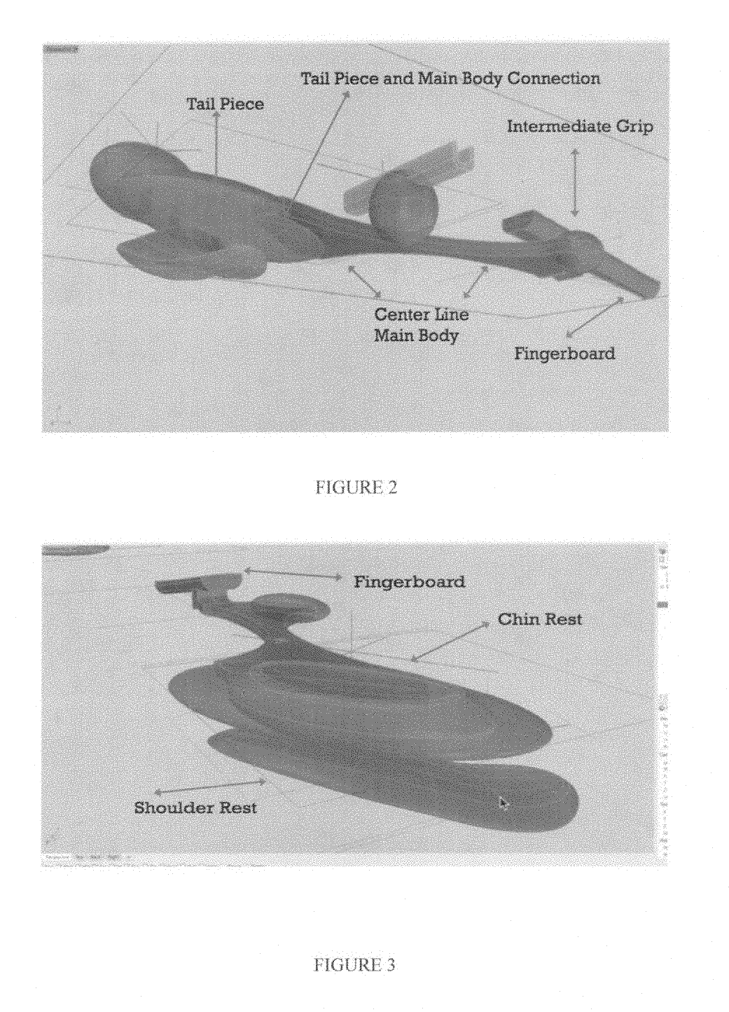

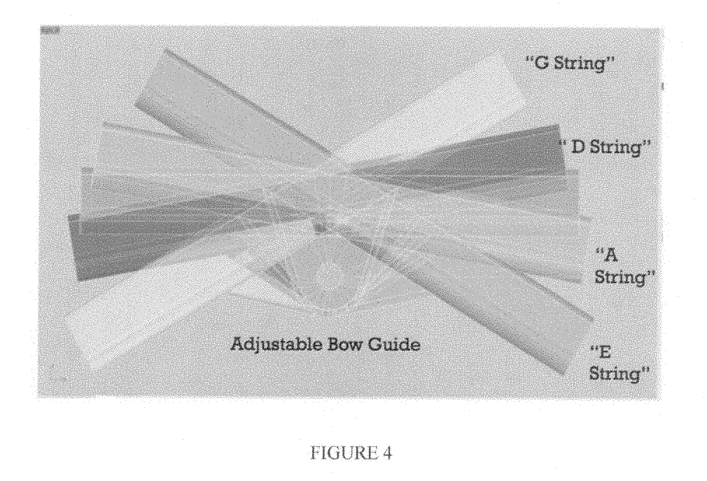

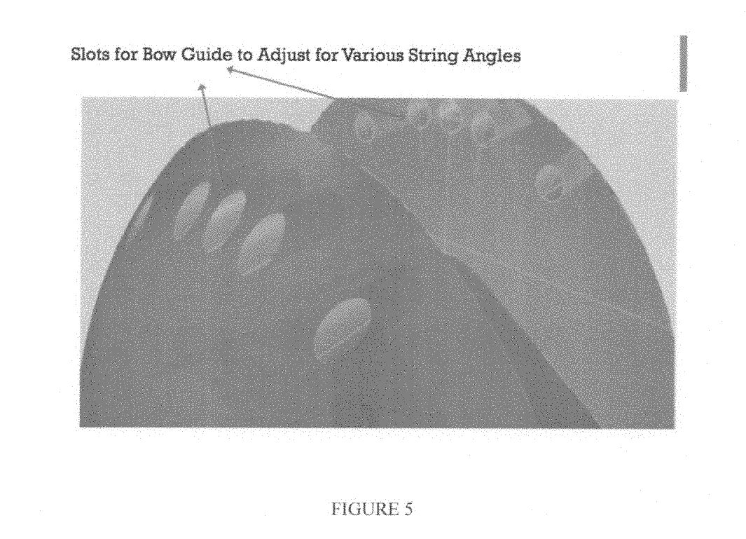

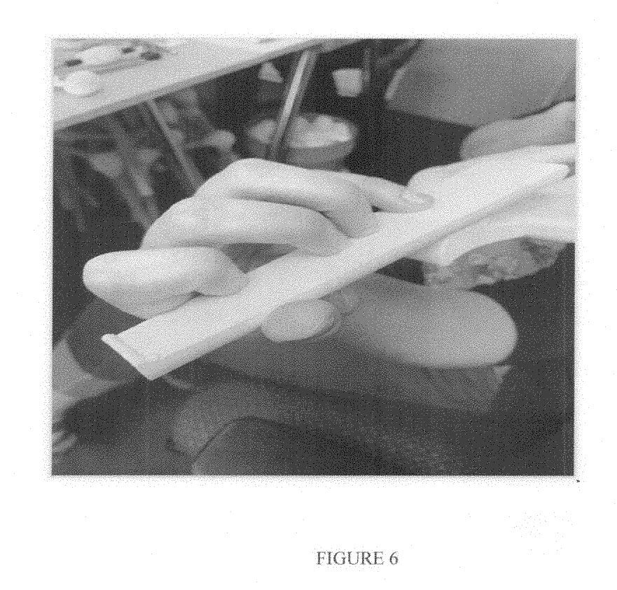

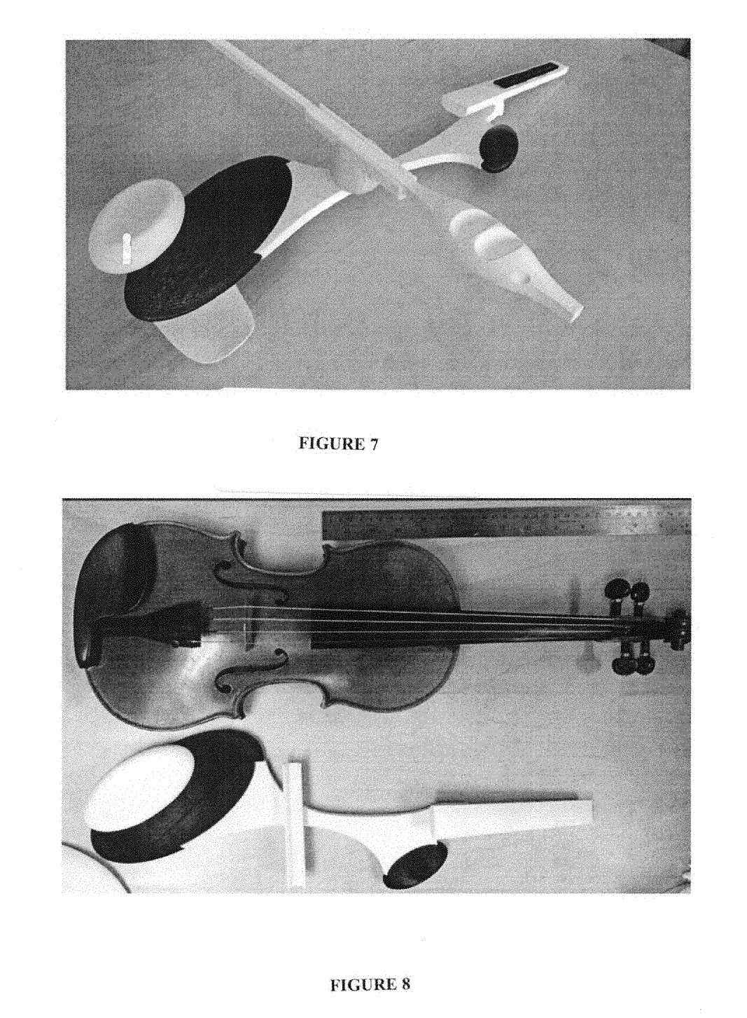

As seen in reference to FIGS. 1-6, to assist with this learning an indented fingerboard has been placed on the 3D instrument to guide young players to correct finger placement in first position (the first set of finger placements a student must learn). Additionally, a left hand shaping guide has been built onto the instrument to form the overall shape of the left hand and left arm.

The right hand controls the bow. The bow is drawn across the strings vibrating them, and sounds the notes being held with the fingers of the left hand. Proper bow technique can be difficult at first. Again, it requires muscle memory to apply the correct speed and pressure with the bow, while coordinating the fingers of the left hand. The smallest variations of speed or pressure can drastically affect the tone of the instrument. Developing this skill is often said to be the most difficult technique to master.

The Violin and Bow Primer has been designed to provide “training wheels” for string playing that reads to music production on traditional wooden violins. The tool accelerates complex and nuanced kinesthetic movements that are often difficult in the first few months of traditional study. The Violin and Bow Primer fosters numerous correct markers of both right and left hand technique in addition to assisting in correct body alignment, including heard, shoulder, and elbow placement in the left arm. For the right hand (bow arm), numerous markers of correct movement and hold are encouraged through indentations of the bulb like frog, and design of a rotational bow (the stick).

The instrument has been designed for comfort with purposeful intention towards making the lightest instrument possible. The instrument facilitates correct body alignment in additional to fostering early foundational movements that lead to superior tone production (right hand) and proper intonation (left hand).

First, the shoulder rest area has been ergonomically designed so that it fits comfortably in the shoulder/chin area of the student. The chin rest on a traditional wooden instrument is non adjustable and usually requires an additional purchase of a tool to help support the instrument during play. This instrument has an upper and lower part designed to help support the violin and develop correct head and shoulder alignment. Additionally, both the upper and lower portions can be snapped off and replaced with various lengths to help customize the size of the area. This is critical as neck length can vary drastically and having a comfortable fit is important in maintaining comfort and balance.

For example, as students grow more relaxed in their bow stroke, various components around the bridge section can be adjusted so increasing autonomy can be achieved and demonstrated. Similarly, in the left hand, 3D printed slides can help students identify where to put their fingers in first position, and be removed as students grow more confident in their abilities.

Set forth as an Appendix is a 9 page document and which is incorporated herein by reference.

The violin of the present invention can be provide from a number of materials including the use of 3D printing materials or can be formed of a molded plastic or resin material. To the extent the training device violin is designed to help beginners learn proper positioning of fingers in the instrument, more durable materials such as wood are not needed and is believed that lightweight materials such as plastics, nylon, and other thermo formable plastics are desired.

Although preferred embodiments of the invention have been described using specific terms, devices, and methods, such description is for illustrative purposes only. The words used are words of description rather than of limitation. It is to be understood that changes and variations may be made by those of ordinary skill in the art without departing from the spirit or the scope of the present invention as set forth herein. In addition, it should be understood that aspects of the various embodiments may be interchanged, both in whole, or in part. Therefore, the spirit and scope of the invention should not be limited to the description of the preferred versions contained therein.

1. A teaching violin comprising:
a violin having a fingerboard having multiple indentations for proper positioning of fingers;
a grip portion defined by a body of the violin that provides for a proper balance and arm form; and
an adjustable bow guide having indented notches that allows for proper angles that mimic the G, D, A, & E string.
